(19) United States
(12) Patent Application Publication
(10) Pub. No.: US 2019/0169339 A1
(43) Pub. Date: Jun. 6, 2019

(54) POLYMER COMPOSITION COMPRISING A (METH)ACRYLIC POLYMER

(71) Applicant: SABIC Global Technologies B.V., Bergen op Zoom (NL)

(72) Inventors: Sharmila Muthukrishnan, Bengaluru (IN); Susanta Mitra, Bangalore, Karnataka (IN); Sathish Nagarajachar, Geleen (NL); Arun Sikder, Banagalore, Karnataka (IN)

(21) Appl. No.: 16/324,423

(22) PCT Filed: Jul. 3, 2017
(86) PCT No.: PCT/EP2017/066480

§ 371 Date: Feb. 8, 2019

(30) Foreign Application Priority Data
Aug. 10, 2016 (EP) 16183559.0

(51) Int. Cl. C08F 220/18; C08F 222/06; C08F 222/40; C08K 5/18; B29C 48/00; B29C 48/14

(52) U.S. Cl. CPC C08F 220/18; C08F 222/06; C08F 222/40; B29K 2033/12; B29C 48/022; B29C 48/14; C08K 5/18

(57) ABSTRACT

The present invention relates to a polymer composition comprising: (a) 54.0-79.0 wt % of a (meth)acrylic polymer; (b) 20.0-45.0 wt % of a copolymer comprising polymeric units according to formula (I) and polymeric units according to formula (II) and (c) 1.0-10.0 wt % of a copolymer comprising polymeric units according to formula (I) and polymeric units according to formula (III), wherein n=0 or 1; with regard to the total weight of the polymer composition. Such polymer composition provides a desired high heat resistance and good scratch resistance.

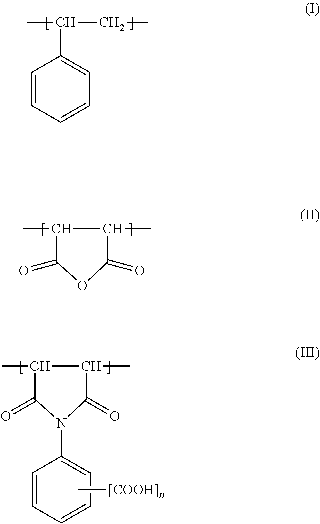

The present invention relates to a polymer composition comprising a (meth)acrylic polymer. The invention further relates to a process for the production of such polymer composition. The invention also relates to articles comprising such polymer composition.

Polymer compositions comprising (meth)acrylic polymers are well-known for their advantageous properties. These advantageous properties include optical properties such as transparency, weathering resistance, hardness, colourability and the ability to be processed into suitable shapes. Polymer composition comprising (meth)acrylic polymers may be thermoplastic, allowing to be moulded into the desired shapes by melt processing, such as via melt extrusion and injection moulding. This allows for a large variety of shapes to be obtained having uniform dimensions and properties.

Due to these favourable properties, (meth)acrylic polymers find extensive usage in for example exterior applications for electronic displays, automotive exterior applications such as lighting components and window applications, as well as in architectural and constructional applications.

A particular property that is applicable in such exterior applications is the scratch resistance. The appearance of scratches not only reduces the durability of products, but also their aesthetics. For that reason, a certain scratch resistance is required.

A further property that is applicable in certain applications is heat resistance. In order to withstand the conditions to which such applications are exposed during their lifetime whilst still maintaining the desired combination of properties, a certain heat resistance is required.

In particular, there is a need for polymer compositions that provide for a good balance of both heat resistance and scratch resistance, preferably whilst still providing the advantageous properties such as transparency, processability, colourability, weathering resistance and hardness.

Various attempts have been presented trying to achieve such balance of properties. For example in U.S. Pat. No. 8,076,435, a copolymer is produced using methyl methacrylate and tricyclodecanyl hydroxymethacrylate. A disadvantage hereof is that a dedicated polymerisation needs to be performed using such specific formulation of monomer and comonomer. This is undesirable from amongst others the viewpoint of process efficiency in polymerisation.

Thus, there remains a need for a polymer composition of having a desired high heat resistance and good scratch resistance, whilst preferably maintaining good optical properties such as transparency and good surface properties.

This has now been achieved according to the present invention by a polymer composition comprising:
(a) 54.0-79.0 wt % of a (meth)acrylic polymer;
(b) 20.0-45.0 wt % of a copolymer comprising polymeric units according to formula (I):

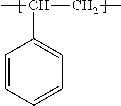

and polymeric units according to formula (II):

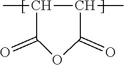

and
(c) 1.0-10.0 wt % of a copolymer comprising polymeric units according to formula (I) and polymeric units according to formula (III):

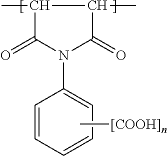

wherein n=0 or 1;
with regard to the total weight of the polymer composition.

Such polymer composition provides a desired high heat resistance and good scratch resistance, whilst maintaining good optical properties such as transparency and good surface properties.

In certain embodiments of the invention, the polymeric units according to formula (III) are polymeric units having the structure:

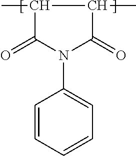

In the case where n=1 in formula (III), the carboxylic moiety in formula (III) may be connected to the aromatic moiety in either the ortho, meta or para position. Preferably, the carboxylic moiety in formula (III) may be connected to the aromatic moiety in the para position. For example, the polymeric units according to formula (III) may be polymeric units having the structure:

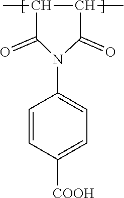

A suitable indicator for the scratch resistance may for example be the residual scratch depth as determined in accordance with ASTM D7187-10.

Suitable indicators for the heat resistance in the context of the present invention may for example be the heat deflection temperature, also referred to as HDT, as determined in accordance with ISO 75-2 (2013), method B, where a higher HDT may be an indicator for a higher heat resistance; the glass transition temperature, also referred to as T_{g}, as determined in accordance with ISO 11357-2 (2013), where a higher T_{g} may be an indicator for a higher heat resistance; and/or the Vicat B softening temperature was determined in accordance with ISO 306 (2013), where a higher Vicat B may be an indicator for a higher heat resistance.

The (meth)acrylic polymer (a) preferably is a polymer comprising ≥95.0% by weight of polymer units according to formula IV, with regard to the total weight of the (meth)acrylic polymer:

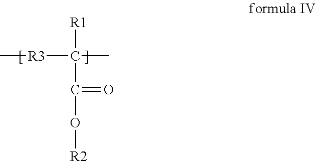

in which:
R1 is hydrogen or a hydrocarbon moiety comprising 1-4 carbon atoms;
R2 is a hydrocarbon moiety comprising 1-4 carbon atoms; and
R3 is a hydrocarbon moiety comprising 1-4 carbon atoms.

Preferably, R1 is CH₃. Preferably, R2 is CH₃. Preferably, R3 is CH₂.

More preferably, R1 is CH₃, R2 is CH₃ and R3 is CH₂.

The (meth)acrylic polymer (a) may for example be a polymer prepared using ≥95.0% by weight, more preferably ≥98.0% or ≥99.0% by weight, with regards to the total weight of the monomers used, of one or more monomers selected from methyl acrylate, methyl-2-methyl acrylate, methyl-2-ethyl acrylate, methyl-2-propyl-acrylate, methyl-2-butyl acrylate, ethyl acrylate, ethyl-2-methyl acrylate, ethyl-2-ethyl acrylate, ethyl-2-propyl acrylate, ethyl-2-butyl acrylate, propyl acrylate, propyl-2-methyl acrylate, propyl-2-ethyl acrylate, propyl-2-propyl acrylate, propyl-2-butyl acrylate, butyl acrylate, butyl-2-methyl acrylate, butyl-2-ethyl acrylate, butyl-2-propyl acrylate, butyl-2-butyl acrylate, t-butyl-2-methyl acrylate, isobutyl-2-methyl acrylate, isopropyl-2-methyl acrylate, or combinations thereof. More preferably, the (meth)acrylic polymer (a) is a polymer prepared using ≥95.0% by weight, more preferably ≥98.0% or ≥99.0% by weight, with regards to the total weight of the monomers used of one or more monomers selected from methyl acrylate, methyl-2-methyl acrylate, butyl-2-methyl acrylate, ethyl acrylate, or combinations thereof.

Preferably, the (meth)acrylic polymer (a) is selected from polymethylmethacrylate (PMMA), polybutylmethacrylate (PBMA), poly(methylmethacrylate-ethylacrylate (PMMA-co-EA), polyethyl acrylate (PEA), polybenzyl methacrylate, poly(n-butyl acrylate), poly(t-butyl acrylate), poly(cyclohexyl methacrylate), poly(1,3-dimethylbutyl methacrylate), poly(3,3-dimethylbutyl methacrylate), poly(diphenylethyl methacrylate), poly(diphenylmethyl methacrylate), poly(dodecyl methacrylate), poly(2-ethylbutyl methacrylate), polyethyl methacrylate, poly(trimethylpropyl methacrylate), poly(n-propylmethacrylate), polyphenyl methacrylate, poly(1-phenylethyl methacrylate), polyoctyl methacrylate, polyneopentyl methacrylate, poly(1-methylpentyl methacrylate), polymethylbutyl methacrylate, polylauryl methacrylate, polyisopropyl methacrylate, polyisopentyl methacrylate, or combinations thereof. More preferably, the (meth)acrylic polymer (a) is selected from polymethylmethacrylate (PMMA), polybutylmethacrylate (PBMA), poly(methylmethacrylate-ethylacrylate (PMMA-co-EA), or polyethyl acrylate (PEA). It is preferred that the (meth)acrylic polymer (a) is polymethylmethacrylate (PMMA).

The PMMA may for example have a melt mass flow rate as determined in accordance with ISO 1133-1 (2011), at 230° C. using a load of 3.80 kg, of ≥0.1 and ≤20.0 g/10 min, alternatively ≥0.5 and ≤10.0 g/10 min, alternatively ≥1.0 and ≤5.0 g/10 min. The use of such PMMA in the preparation of a polymer composition according to the invention may for example result in a polymer composition having such flow properties allowing for the production of transparent articles of the polymer composition via injection moulding.

The copolymer (b) may for example be a SMA copolymer (styrene-maleic anhydride copolymer). The SMA copolymer may for example comprise ≥10.0 wt % and ≤50.0 wt % of polymer units derived from maleic anhydride, with regard to the total weight of the copolymer (b), alternatively ≥15.0 wt % and ≤40.0 wt %, alternatively ≥20.0 wt % and ≤35.0 wt %, alternatively ≥20.0 wt % and ≤30.0 wt %. The SMA copolymer may for example have an intrinsic viscosity, also referred to as IV, of ≥0.20 and ≤1.00 dl/g, alternatively ≥0.30 and ≤0.75 dl/g, alternatively ≥0.40 and ≤0.60 dl/g, as determined in accordance with ISO 1628-1:2009. The SMA copolymer may for example have a Vicat softening temperature of ≥100° C., alternatively ≥120° C., alternatively ≥140° C., such as ≥140° C. and ≤180° C., as determined in accordance with ISO 306 (2013), method B120.

The copolymer (b) preferably comprises ≥5.0 wt % of polymeric units according to formula (II), with regard to the total weight of the copolymer (b). Alternatively, the copolymer (b) may comprise ≥10.0 wt % and ≤50.0 wt % of polymeric units according to formula (II), alternatively ≥15.0 wt % and ≤40.0 wt %, alternatively ≥20.0 wt % and ≤35.0 wt %, alternatively ≥20.0 wt % and ≤30.0 wt %, with regard to the total weight of copolymer (b). Preferably, the copolymer (b) comprises ≥20.0 wt % and ≤30.0 wt % of polymeric units according to formula (II) with regard to the total weight of copolymer (b).

The polymer composition may for example comprise 20.0-45.0 wt % of copolymer (b), with regard to the total weight of the polymer composition; alternatively, the polymer composition may comprise 20.0-40.0 wt/o of copolymer (b), or 20.0-35.0 wt %, with regard to the total weight of the polymer composition. More preferably, the polymer composition comprises 25.0-35.0 wt % of copolymer (b) with regard to the total weight of the polymer composition. Preferably, the polymer composition comprises 25.0-35.0 wt % of copolymer (b) with regard to the total weight of the polymer composition.

In a particularly preferred embodiment, the copolymer (b) is essentially free from polymeric units according to formula (III). For example, the copolymer (b) may comprise less than 1.0 wt % of polymeric units according to formula (III), alternatively less than 0.5 wt %, alternatively less than 0.1 wt %, with regard to the total weight of the copolymer (b).

The polymer composition according to the present invention may for example comprise 2.0-8.0 wt % of copolymer (c) with regard to the total weight of the polymer composition.

Alternatively, the polymer composition may comprise 2.0-6.0 wt % of copolymer (c) or 2.5-5.0 wt %, with regard to the total weight of the polymer composition.

The copolymer (c) may for example comprise ≥5 wt % of polymeric units according to formula (III), with regard to the total weight of the copolymer (c). Alternatively, the copolymer (c) may comprise ≥5.0 wt % and ≤50.0 wt % of polymeric units according to formula (III), alternatively ≥10.0 wt % and ≤30.0 wt %, alternatively ≥15.0 wt % and ≤25.0 wt %, with regard to the total weight of copolymer (c). Preferably, the copolymer (c) comprises ≥15.0 and ≤25.0 wt % of polymeric units according to formula (III) with regard to the total weight of the copolymer (c).

In certain embodiments, the copolymer (c) also comprises polymeric units according to formula (II). For example, the copolymer (c) may comprise ≥5 wt % of polymeric units according to formula (II), with regard to the total weight of the copolymer (c). Alternatively, the copolymer (c) may comprise ≥5.0 wt % and ≤20.0 wt % of polymeric units according to formula (II), alternatively ≥7.5 wt % and ≤15.0 wt %, with regard to the total weight of copolymer (c). For example, the copolymer (c) may comprise ≥7.5 and ≤15.0 wt % of polymeric units according to formula (II) with regard to the total weight of the copolymer (c).

In a particular embodiment, the copolymer (c) comprises ≥15.0 wt % and ≤25.0 wt % of polymeric units according to formula (III) and ≥7.5 wt % and ≤15.0 wt % of polymeric units according to formula (II).

The copolymer (c) may in an exemplary embodiment be prepared by melt blending of the copolymer (b) with p-amino benzoic acid, wherein the copolymer (b) and the p-amino benzoic acid react in the melt to obtain the copolymer (c). The copolymer (c) may also be referred to as a styrene-maleimide copolymer or SMI. The reactive melt blending of the copolymer (b) and the p-amino benzoic acid preferably is performed under such conditions that essentially all polymeric units according to formula (II) are converted into polymeric units according to formula (III). For example, the conversion of essentially all polymeric units according to formula (II) may be understood as to result in less than 100 ppm of units according to formula (II) remaining in the copolymer (c), preferably less than 75 ppm.

In a certain embodiment, the copolymer (c) is prepared by reacting the copolymer (b) with p-amino benzoic acid. Such reaction may for example be performed in a melt extruder.

The use of such copolymer (c) in the polymer composition according to the present invention contributes to the achievement of a desired high heat resistance. The use of such copolymer (c) in such quantities contributes to the achievement of a desired high heat resistance whilst maintaining good optical properties such as transparency and good surface properties, as well as good mechanical properties.

It is preferred that the polymer composition according to the present invention comprises ≥80.0 wt % with regard to the total weight of the polymer composition of the sum of (meth)acrylic polymer (a), copolymer (b) and copolymer (c), more preferably ≥90.0 wt %, even more preferably ≥95.0 wt %, or ≥99.0 wt %.

The polymer composition according to the present invention preferably comprises 64.0-74.0 wt % of (meth)acrylic polymer (a), 25.0-35.0 wt % of copolymer (b), and 1.0-8.0 wt % of copolymer (c), with regard to the total weight of the polymer composition.

The polymer composition may optionally comprise further ingredients such as antioxidants. These antioxidants may for example be phenolic antioxidants and/or phosphite antioxidants. A stabiliser composition comprising one or more phenolic antioxidant(s) and one or more phosphite antioxidant(s) may for example be used. Phenolic antioxidants may for example be selected from monophenolic antioxidants, i.e. antioxidants containing one phenolic group per molecule, bisphenolic antioxidants i.e. antioxidants containing two phenolic groups per molecule, and polyphenolic antioxidants, i.e. antioxidants containing more than two phenolic groups per molecule, including 1,1,3-tris(2-methyl-4-hydroxy-5-t-butyl phenyl) butane, pentaerythritol tetrakis(3-(3,5-di-t-butyl-4-hydroxyphenyl)propionate, 1,3,5-trimethyl-2,4,6-tris(3,5-di-t-butyl-4-hydroxybenzyl)benzene, 1,3,5-tris(3,5-di-t-butyl-4-hydroxybenzyl)isocyanurate, and 1,3,5-tris(4-t-butyl-2,6-dimethyl-3-hydroxybenzyl)isocyanurate.

Preferably, the phenolic antioxidant is pentaerythritol tetrakis(3-(3,5-di-t-butyl-4-hydroxyphenyl)propionate.

Phosphite antioxidants may for example be selected from trisnonylphenyl phosphite, trilauryl phosphite, tris(2,4-di-t-butylphenyl)phosphite, triisodecyl phosphite, diisodecyl phenyl phosphite, diphenyl isodecyl phosphite, and triphenyl phosphite. Preferably, the phosphite antioxidant is tris(2,4-di-t-butylphenyl)phosphite.

Preferably, the stabiliser composition comprises pentaerythritol tetrakis(3-(3,5-di-t-butyl-4-hydroxyphenyl)propionate.

The polymer composition may for example comprise ≥0.10 and ≤1.00 wt % of antioxidant, with regard to the total weight of the polymer composition, preferably ≥0.20 and ≤0.50 wt %.

The polymer composition may optionally comprise further ingredients such as heat stabilisers. The heat stabilisers may for example be a nitrogen-containing compounds. Such nitrogen-containing heat stabilisers may for example be one or more selected from the list consisting of aminotriazine compounds, allantoin, hydrazides, polyamids, melamines, and/or mixtures thereof.

The nitrogen-containing compound can be a low molecular weight compound or a high molecular weight compound. Examples of low molecular weight nitrogen-containing compounds can include an aliphatic amine (e.g., monoethanolamine, diethanolamine, and tris-(hydroxymethyl)aminomethane), an aromatic amine (e.g., an aromatic secondary or tertiary amine such as o-toluidine, p-toluidine, p-phenylenediamine, o-aminobenzoic acid, p-aminobenzoic acid, ethyl o-aminobenzoate, or ethyl p-aminobenzoate), an imide compound (e.g., phthalimide, trimellitimide, and pyromellitimide), a triazole compound (e.g., benzotriazole), a tetrazole compound (e.g., an amine salt of 5,5′-bitetrazole, or a metal salt thereof), an amide compound (e.g., a polycarboxylic acid amide such as malonamide or isophthaldiamide, and p-aminobenzamide), hydrazine or a derivative thereof (e.g., an aliphatic carboxylic acid hydrazide such as hydrazine, hydrazone, a carboxylic acid hydrazide (stearic hydrazide, 12-hydroxystearic hydrazide, adipic dihydrazide, sebacic dihydrazide, or dodecane diacid dihydrazide; and an aromatic carboxylic acid hydrazide such as benzoic hydrazide, naphthoic hydrazide, isophthalic dihydrazide, terephthalic dihydrazide, naphthalenedicarboxylic dihydrazide, or benzenetricarboxylic trihydrazide)), a polyaminotriazine (e.g., guanamine or a derivative thereof, such as guanamine, acetoguanamine, benzoguanamine, succinoguanamine, adipoguanamine, 1,3,6-tris(3,5-diamino-2,4,6-triazinyl)hexane, phthaloguanamine or CTU-guanamine, melamine or a derivative thereof (e.g., melamine, and a condensate of melamine, such as melam, melem or melon)), a salt of a polyaminotriazine compound containing melamine and a melamine derivative with an organic acid, a salt of a polyaminotriazine compound containing melamine and a melamine derivative with an inorganic acid, uracil or a derivative thereof (e.g., uracil, and uridine), cytosine or a derivative thereof (e.g., cytosine, and cytidine), guanidine or a derivative thereof (e.g., a non-cyclic guanidine such as guanidine or cyanoguanidine; and a cyclic guanidine such as creatinine), and urea or a derivative thereof.

The polymer composition may for example comprise ≥0.10 and ≤1.00 wt % of heat stabilisers, with regard to the total weight of the polymer composition, preferably ≥0.20 and ≤0.50 wt %.

It is particularly preferred that the polymer composition according to the invention has:
a heat deflection temperature as determined as determined as the temperature of deflection under load, in accordance with ISO 75-2 (2013), method B, of ≥110° C.;
a Vicat B softening temperature as determined in accordance with ISO 306 (2013), using a force of 50 N and a heating rate of 120 K/h of ≥120° C.; and/or
a Yellowness Index as determined in accordance with ASTM E313 (2010) of ≤5.0.

The invention also in a particular embodiment relates to an article produced using the polymer composition according to the invention. In particular, it is preferred that such articles has a residual scratch depth as determined in accordance with ASTM D7187 (2010) of ≤1500 nm.

The polymer composition according to the present invention may for example be prepared by melt mixing of a mixture comprising (meth)acrylic polymer (a), copolymer (b) and copolymer (c) in a melt extruder, wherein the melt extruder comprises:
(i) an inlet for feeding the mixture;
(ii) a barrel comprising one or more extruder screw(s) each comprising a tip;
(iii) one or more opening(s) for removing the obtained polymer composition from the extruder; and
(iv) a volume of space in the area between the tip(s) of the extruder screw(s) and the opening(s) for removing the obtained polymer composition
wherein during the melt mixing the temperature of the polymer composition in the volume of space (iv) is ≥235° C. and ≤255° C.

Suitable melt extruders for preparation of the polymer compositions are well known. It is preferred that the melt extruder comprises at least two extruder screws wherein the extruder screws are co-rotating or counter-rotating, and wherein the melt extruder is designed such to ensure the feed mixture to be transported from the feed inlet to the opening for removing the obtained polymer composition and to ensure the feed mixture to be subjected to sufficient heat to result in the polymer composition in the volume of space (iv) to have a temperature of ≥235° C. and ≤255° C. It is preferred that the melt extruder comprises two extruder screws wherein the extruder screws are co-rotating. Heat may be supplied to the feed mixture in the melt extruder by in the form of shear induced by rotation of the extruder screws and/or by supply of extemal heat such as via a heating jacket positioned around the barrel of the melt extruder.

Preferably, the temperature of the polymer composition during the melt mixing in the volume of space (iv) is ≥240° C. and ≤250° C.

A polymer composition according to the present invention may for example by prepared via a process comprising the following steps in this order:
continuously feeding the mixture comprising (a), (b) and (c) and optionally further ingredients to the inlet (i) of a melt extruder;
subjecting the mixture to rotation of the screws such as to result in the transportation of the mixture towards the opening(s) (iii);
continuously removing the obtained polymer composition from the opening(s) (iii); and
cooling the obtained polymer composition to obtain a solid composition.

In addition to inlet (i), the melt extruder may optionally have further inlet(s) for feeding the mixture of ingredients to the melt extruder.

The obtained polymer composition may be removed from the extruder from the opening(s) (iii), wherein the opening(s) may be present in the form of circular openings or holes. The obtained polymer composition may leave the melt extruder in the form of strands, wherein the polymer composition upon leaving the extruder is in molten state. The molten strands leaving the extruder may be subjected to cooling to a temperature below the melting point of the polymer composition. For example, the molten strands may be cooled to below 100° C. this cooling may be achieved by subjecting the molten strands to water having a temperature of for example ≤50° C.

It is preferred that the process for preparation of the polymer composition according to the invention is a continuous process.

An embodiment of the invention relates to a polymer composition comprising:
(a) 54.0-79.0 wt % of a (meth)acrylic polymer;
(b) 20.0-45.0 wt % of a copolymer comprising polymeric units according to formula (I):

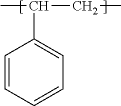

and polymeric units according to formula (II):

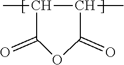

and
(c) 1.0-10.0 wt % of a copolymer comprising polymeric units according to formula (I) and polymeric units according to formula (III):

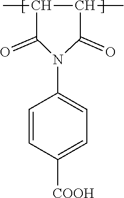

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises ≥15.0 wt % and ≤25.0 wt % of polymeric units according to formula (III) and Z 7.5 wt % and ≤15.0 wt % of polymeric units according to formula (II).

In another embodiment, the invention relates to a polymer composition comprising:
(a) 54.0-79.0 wt % of a (meth)acrylic polymer;
(b) 20.0-45.0 wt % of a copolymer comprising polymeric units according to formula (I):

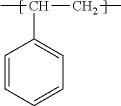

and polymeric units according to formula (II):

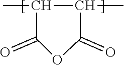

and
(c) 1.0-10.0 wt % of a copolymer comprising polymeric units according to formula (I) and polymeric units according to formula (III):

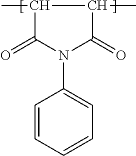

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises ≥15.0 wt % and ≤25.0 wt % of polymeric units according to formula (III) and ≥7.5 wt % and ≤15.0 wt/o of polymeric units according to formula (II).

In a particularly preferred embodiment, the present invention relates to a polymer composition comprising:
(a) 54.0-79.0 wt % of a (meth)acrylic polymer;
(b) 20.0-45.0 wt % of a copolymer comprising polymeric units according to formula (I):

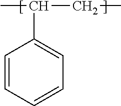

and polymeric units according to formula (II):

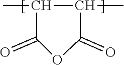

and
(c) 1.0-10.0 wt % of a copolymer comprising polymeric units according to formula (I) and polymeric units according to formula (III):

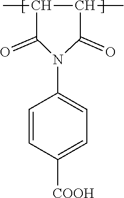

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises less 100 ppm of units according to formula (II).

In a further particularly preferred embodiment, the present invention relates to a polymer composition comprising:
(a) 54.0-79.0 wt % of a (meth)acrylic polymer;
(b) 20.0-45.0 wt % of a copolymer comprising polymeric units according to formula (I):

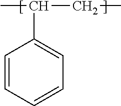

and polymeric units according to formula (II):
   and

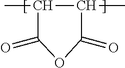

(c) 1.0-10.0 wt % of a copolymer comprising polymeric units according to formula (I) and polymeric units according to formula (III):

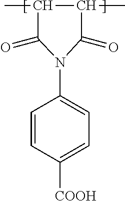

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises less 100 ppm of units according to formula (II);

wherein the polymer composition comprises ≥95.0 wt % with regard to the total weight of the polymer composition of the sum of (meth)acrylic polymer (a), copolymer (b) and copolymer (c).

In a further particularly preferred embodiment, the present invention relates to a polymer composition comprising:
(a) 54.0-79.0 wt % of a (meth)acrylic polymer;
(b) 20.0-45.0 wt % of a copolymer comprising polymeric units according to formula (I)

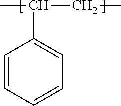

and polymeric units according to formula (II):

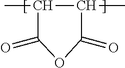

and
(c) 1.0-8.0 wt % of a copolymer comprising polymeric units according to formula (I) and polymeric units according to formula (III):

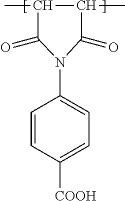

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises less 100 ppm of units according to formula (II);

wherein the polymer composition comprises ≥95.0 wt % with regard to the total weight of the polymer composition of the sum of (meth)acrylic polymer (a), copolymer (b) and copolymer (c).

In a further particularly preferred embodiment, the present invention relates to a polymer composition comprising:
(a) 54.0-79.0 wt % of a (meth)acrylic polymer;
(b) 20.0-45.0 wt % of a copolymer comprising polymeric units according to formula (I):

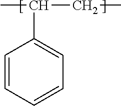

and polymeric units according to formula (II):

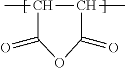

and
(c) 1.0-6.0 wt % of a copolymer comprising polymeric units according to formula (I) and polymeric units according to formula (III):

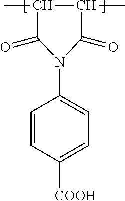

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises less 100 ppm of units according to formula (II);

wherein the polymer composition comprises ≥95.0 wt % with regard to the total weight of the polymer composition of the sum of (meth)acrylic polymer (a), copolymer (b) and copolymer (c).

In a further particularly preferred embodiment, the present invention relates to a polymer composition comprising:
(a) 54.0-79.0 wt % of a (meth)acrylic polymer;
(b) 20.0-45.0 wt % of a copolymer comprising polymeric units according to formula (I):

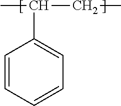

and polymeric units according to formula (II):

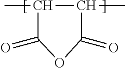

and
(c) 1.0-6.0 wt % of a copolymer comprising polymeric units according to formula (I) and polymeric units according to formula (III):

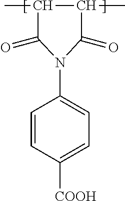

with regard to the total weight of the polymer composition;

wherein the (meth)acrylic polymer (a) is polymethylmethacrylate (PMMA), the copolymer (b) comprises ≥10.0 wt % and ≤50.0 wt % of polymeric units according to formula (II), and wherein the copolymer (c) comprises less 100 ppm of units according to formula (II);

wherein the polymer composition comprises ≥95.0 wt % with regard to the total weight of the polymer composition of the sum of (meth)acrylic polymer (a), copolymer (b) and copolymer (c), and wherein copolymer (c) comprises ≥15.0 and ≤25.0 wt % of polymeric units according to formula (III) with regard to the total weight of the copolymer (c).

The invention will now be illustrated by the following non-limiting examples.

TABLE I
Materials used

| | |
|---|---|
| PMMA | SABIC 20HR, a polymethylmethacrylate, obtainable from SABIC |
| SMA | XIRAN SZ26120, a copolymer prepared using styrene and maleic |
| | anhydride, comprising 26 wt % of polymer units derived from maleic |
| | anhydride, obtainable from Polyscope, The Netherlands |
| Terpolymer | XIRAN IZ1018M, a copolymer comprising 10 wt % of polymer units derived |
| | from maleic anhydride, 18 wt % of polymer units derived from n-phenyl |
| | maleimide, and 72 wt % of polymer units derived from styrene, obtainable |
| | from Polyscope, The Netherlands |

Preparation of SMI

A quantity of 200 g of SMA was mixed with 80 g p-amino benzoic acid. The obtained mixture was subjected to melt mixing using an intermeshing Coperion ZSK-25 twin-screw melt extruder equipped with a vacuum port at a melt temperature of 230° C. The barrel temperature was maintained at 230° C., and the screws were operated at a speed of 300 rpm, with a feed rate of 8 kg/h. The extrudate was cut into pellets and dried for 4 h at 80° C. The dried pellets were ground to obtain a powder which was washed with methanol to remove the unreacted p-aminobenzoic acid, and subsequently dried at 80° C. for another 24 h. The dried powder contained 65 ppm of polymer units derived from maleic anhydride.

Preparation of Polymer Compositions

Polymer compositions were prepared by melt mixing the formulations as presented in table II using an intermeshing Coperion ZSK-25 twin-screw melt extruder at a melt temperature of 235° C. The barrel temperature was maintained at 230° C., and the screws were operated at a speed of 300 rpm, with a feed rate of 8 kg/h. The extrudate was cut into pellets. The melt temperature was determined in the volume of space in the area between the tips of the extruder screws and the openings for removing the obtained polymer composition.

TABLE II
formulations of polymer compositions

| Example | PMMA | SMA | SMI | Terpolymer |
|---|---|---|---|---|
| 1 | 70.0 | 25.0 | 5.0 | |
| 2 | 70.0 | 27.5 | 2.5 | |
| 3 | 70.0 | 20.0 | 10.0 | |
| 4 | 70.0 | 27.5 | | 2.5 |
| 5 | 70.0 | 25.0 | | 5.0 |
| 6 | 70.0 | 20.0 | | 10.0 |
| 7 (C) | 70.0 | | | 30.0 |
| 8 (C) | 70.0 | 30.0 | | |
| 9 (C) | 95.0 | | | 5.0 |
| 10 (C) | 100.0 | | | |

The values in table II are in parts by weight. Examples 1-6 represent the present invention; examples 7-10 are included for comparative purposes.

The polymer compositions obtained were subjected to testing of material properties, the results of which are listed in table III.

TABLE III
material properties of polymer compositions

| | | Example | | | | | | | | | |
|---|---|---|---|---|---|---|---|---|---|---|---|
| Property | Unit | 1 | 2 | 3 | 4 | 5 | 6 | 7 | 8 | 9 | 10 |
| T_{g} | ° C. | 128 | 127 | 127 | 127 | 125 | 125 | 115 | 126 | 114 | 114 |
| HDT | ° C. | 111 | 111 | 109 | 112 | 111 | 111 | 113 | 109 | | 99 |
| Vicat B | ° C. | 122 | 122 | 120 | 120 | 121 | 121 | 116 | 118 | 109 | 108 |
| Transmission | % | 87 | 88 | 74 | 91 | | | | 91 | | 93 |
| Haze | % | 3.5 | 3.2 | 10.5 | 3.0 | | | | 2.6 | | 2.3 |
| YI | — | 4.2 | 3.5 | 11.5 | | | | | 3.0 | | 2.9 |
| Impact | kJ/m² | 2.15 | 2.20 | 1.98 | 2.30 | 2.32 | 2.20 | 2.34 | 2.24 | 2.31 | 2.10 |
| strength | | | | | | | | | | | |
| Residual | nm | 1449 | 1444 | 1552 | 1456 | 1432 | 1423 | 1264 | 1492 | | 1289 |
| depth | | | | | | | | | | | |
| Hardness | GPa | 0.27 | 0.27 | 0.27 | 0.27 | 0.27 | 0.27 | 0.27 | 0.27 | | 0.26 |

Wherein:

T_{g} is the glass transition temperature as determined in accordance with ISO 11357-2 (2013).

HDT is the heat deflection temperature as determined as the temperature of deflection under load, in accordance with ISO 75-2 (2013), method B.

Vicat B softening temperature was determined in accordance with ISO 306 (2013), using a force of 50 N and a heating rate of 120 K/h.

Transmission is the luminous transmittance as determined in accordance with ASTM D1003 (2000).

Haze was determined in accordance with ASTM D1003 (2000).

YI is the Yellowness Index as determined in accordance with ASTM E313 (2010).

Impact strength is the Izod impact strength as determined in accordance with ISO 180 (2000), notch type A, at 23° C.

Residual depth is the depth of scratches induced by the nano-scratching method as determined in accordance with ASTM D7187 (2010). Nano-scratch testing was done with an increased load of 0-120 mN using a Berkovich indenter with a tip diameter of 50 nm. Depth was measured at a load of 48 mN.

Hardness is determined in as the indentation hardness in accordance with ISO 14577-1 (2015). Hardness was determined using a Berkovich indenter with a tip diameter of 20 nm. Indentations were made with a constant strain rate of 0.05 s⁻¹ and indentation depth of 2 μm.

The presented examples indicate that a polymer composition according to the present invention has a desirably good combination of heat resistance and scratch resistance, combined with amongst other good optical properties and impact strength.

1. A polymer composition comprising:
(a) 54.0-79.0 wt % of a (meth)acrylic polymer;
(b) 20.0-45.0 wt % of a copolymer comprising polymeric units according to formula (I): 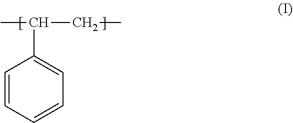
and polymeric units according to formula (II): 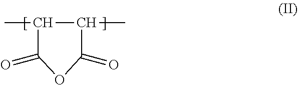
and
(c) 1.0-10.0 wt % of a copolymer comprising polymeric units according to formula (I) and polymeric units according to formula (III): 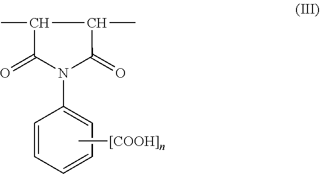
wherein n=0 or 1;
with regard to the total weight of the polymer composition.

2. The polymer composition according to claim 1 comprising 2.0-8.0 wt % of the copolymer (c) with regard to the total weight of the polymer composition.

3. The polymer composition according to claim 1 wherein the (meth)acrylic polymer (a) comprises ≥95.0% by weight, with regard to the total weight of the (meth)acrylic polymer (a), of polymeric units according to formula IV: 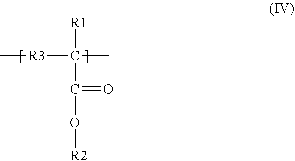
in which:
R1 is hydrogen or a hydrocarbon moiety comprising 1-4 carbon atoms;
R2 is a hydrocarbon moiety comprising 1-4 carbon atoms; and
R3 is a hydrocarbon moiety comprising 1-4 carbon atoms.

4. The polymer composition according to claim 1 wherein the (meth)acrylic polymer (a) is a polymer prepared using ≥95% by weight with regard to the total weight of the monomers used of one or more monomers selected from methyl acrylate, methyl-2-methyl acrylate, methyl-2-ethyl acrylate, methyl-2-propyl-acrylate, methyl-2-butyl acrylate, ethyl acrylate, ethyl-2-methyl acrylate, ethyl-2-ethyl acrylate, ethyl-2-propyl acrylate, ethyl-2-butyl acrylate, propyl acrylate, propyl-2-methyl acrylate, propyl-2-ethyl acrylate, propyl-2-propyl acrylate, propyl-2-butyl acrylate, butyl acrylate, butyl-2-methyl acrylate, butyl-2-ethyl acrylate, butyl-2-propyl acrylate, butyl-2-butyl acrylate, t-butyl-2-methyl acrylate, isobutyl-2-methyl acrylate, isopropyl-2-methyl acrylate, or combinations thereof.

5. The polymer composition according to claim 1 wherein the (meth)acrylic polymer (a) is selected from polymethylmethacrylate (PMMA), polybutylmethacrylate (PBMA), poly(methylmethacrylate-ethylacrylate) (PMMA-co-EA), polyethyl acrylate (PEA), polybenzyl methacrylate, poly(n-butyl acrylate), poly(t-butyl acrylate), poly(cyclohexyl methacrylate), poly(1,3-dimethylbutyl methacrylate), poly(3,3-dimethylbutyl methacrylate), poly(diphenylethyl methacrylate), poly(diphenylmethyl methacrylate), poly(dodecyl methacrylate), poly(2-ethylbutyl methacrylate), polyethyl methacrylate, poly(trimethylpropyl methacrylate), poly(n-propylmethacrylate), polyphenyl methacrylate, poly(1-phenylethyl methacrylate), polyoctyl methacrylate, polyneopentyl methacrylate, poly(1-methylpentyl methacrylate), polymethylbutyl methacrylate, polylauryl methacrylate, polyisopropyl methacrylate, polyisopentyl methacrylate, or combinations thereof.

6. The polymer composition according to claim 1 wherein the (meth)acrylic polymer (a) is selected from polymethylmethacrylate (PMMA), polybutylmethacrylate (PBMA), poly(methylmethacrylate-ethylacrylate) (PMMA-co-EA), or polyethyl acrylate (PEA).

7. The polymer composition according to claim 1 wherein the (meth)acrylic polymer (a) is polymethylmethacrylate (PMMA).

8. The polymer composition according to claim 1 wherein the polymer composition is prepared by melt mixing of a mixture comprising (meth)acrylic polymer (a), copolymer (b) and copolymer (c) in a melt extruder, wherein the melt extruder comprises:
(i) an inlet for feeding the mixture;
(ii) a barrel comprising one or more extruder screw(s) each comprising a tip;
(iii) one or more opening(s) for removing the obtained polymer composition from the extruder; and
(iv) a volume of space in the area between the tip(s) of the extruder screw(s) and the opening(s) for removing the obtained polymer composition
wherein during the melt mixing the temperature of the polymer composition in the volume of space (iv) is ≥235° C. and ≤255° C.

9. The polymer composition according to claim 1 wherein the polymer composition comprises 64.0-74.0 wt % of (meth)acrylic polymer (a), 25.0-35.0 wt % of copolymer (b), and 1.0-8.0 wt % of copolymer (c), with regard to the total weight of the polymer composition.

10. The polymer composition according to claim 1 wherein the copolymer (b) comprises ≥5.0 wt % of polymeric units according to formula (II), with regard to the total weight of the copolymer (b).

11. The polymer composition according to claim 1 wherein the copolymer (c) is prepared by reacting copolymer (b) with p-amino benzoic acid.

12. The polymer composition according to claim 1 wherein:
the (meth)acrylic polymer (a) has a melt mass flow rate as determined in accordance with ISO 1133-1 (2011), at 230° C. using a load of 3.80 kg, of ≥0.1 and ≤20.0 g/10 min; and/or
the copolymer (b) has an intrinsic viscosity of ≥0.20 and ≤1.00 dl/g as determined in accordance with ISO 1628-1:2009.

13. The polymer composition according to claim 1 wherein the polymer composition has:
a heat deflection temperature determined as the temperature of deflection under load, in accordance with ISO 75-2 (2013), method B, of ≥110° C.;
a Vicat B softening temperature as determined in accordance with ISO 306 (2013), using a force of 50 N and a heating rate of 120 K/h of ≥120° C.; and/or
a Yellowness Index as determined in accordance with ASTM E313 (2010) of ≤5.0.

14. An article produced using the polymer composition according to claim 1.

15. An article according to claim 14 having a residual scratch depth as determined in accordance with ASTM D7187 (2010) of ≤1500 nm.
